(19) United States
(12) Patent Application Publication
(10) Pub. No.: US 2009/0007714 A1
(43) Pub. Date: Jan. 8, 2009

(54) Vehicle Steering Assembly

(76) Inventor: Tony J. Carlini, Newport Beach, CA (US)

Correspondence Address: THE ECLIPSE GROUP LLP, 10605 BALBOA BLVD., SUITE 300, GRANADA HILLS, CA, 91344, US

(21) Appl. No.: 12/278,538

(22) PCT Filed: Feb. 6, 2007
(86) PCT No.: PCT/US07/03117

§ 371 Date: Aug. 6, 2008

Related U.S. Application Data
(60) Provisional application No. 60/765,567, filed on Feb. 6, 2006.

(51) Int. Cl. B62D 1/16

(52) U.S. Cl. 74/492

(57) ABSTRACT

A vehicle steering assembly is provided that includes a triple tree integrated with two handlebars. Each of the two handlebars is integrated at a transition region with the triple tree. The triple tree includes two fork-receiving recesses and a neck-receiving top pipe recess. A method including providing such a vehicle steering assembly further having an opening at each of two different locations in the triple tree and a hollow interior including an interior channel communicating with the two openings in the triple tree; and routing a wire through the channel between the two openings.

### RELATED APPLICATIONS

This application claims priority of U.S. Provisional Patent Application Ser. No. 60/765,567, filed Feb. 6, 2006, the entirety of the application of which is incorporated by reference into this application.

### BACKGROUND OF THE INVENTION

1. Field of the Invention

This invention relates to steering assemblies for vehicles having a steerable wheel, and in particular to steering assemblies for motorcycles.

2. Related Art

Steering assemblies are utilized in a broad range of vehicles having a steerable wheel, such as motorcycles. A motorcycle steering assembly transmits rotational torque, from handlebars controlled by a rider, to turn a steerable wheel. Structural and aesthetic designs for motorcycles and other vehicles having a steerable wheel are legion, with much attention paid to both the safety and the aerodynamic contours of the vehicle. In spite of such developments, there remains a continuing need for improved steering assemblies for incorporation into vehicles having a steerable wheel.

### SUMMARY

In an example of an implementation, a vehicle steering assembly is provided including a triple tree and two handlebars. Each of the two handlebars is integrated at a transition region with the triple tree. The triple tree includes two fork-receiving recesses and a neck-receiving top pipe recess. As an example, the triple tree may include three spaced-apart rounded corners each forming a vertex of a triangular body, each of the two fork-receiving recesses and the neck-receiving top pipe recess being located at one of the rounded corners. In further examples, the vehicle steering assembly may include a plurality of interior channels, which may be interconnected. The vehicle steering assembly may include openings in the triple tree, located for example, at the two fork-receiving recesses or the neck-receiving top pipe recess, which openings are in communication with the interior channel. Other openings or access holes may be positioned at various locations along the vehicle steering assembly to supply access to the interior channels of the steering assembly.

In yet another example of an implementation, a modular vehicle steering assembly is provided that allows for the interconnection of the two handlebars with the triple tree. In this example, the vehicle steering assembly may further include interior channels that are in communication with one another through the modular attachment of the handlebars with the triple tree.

In another example of an implementation, the handlebars may include removeably coupled grip bars. The removeably coupled grip bars may further include interior channels that align with and are in communication with the interior channels of the handlebars.

A method is provided as a further example of an implementation, including providing a vehicle steering assembly having a triple tree and two handlebars, each of the two handlebars being integrated at a transition region with the triple tree, the triple tree including two fork-receiving recesses, a neck-receiving top pipe recess, a hollow interior and openings in the two-fork receiving recesses and/or neck-receiving top pipe recess that allow the two-fork receiving recesses and/or neck-receiving top pipe recess to be in communication with the interior channel. The method additionally includes routing a wire through the interior channel of the vehicle steering assembly. The method may, for example, also include providing a vehicle steering assembly having removeably coupled grip bars integrated with each handlebar, each grip bar including an opening at each of two different locations and an interior channel communicating with the two openings; and routing the wire through the channel between the two openings in the grip bar.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed on illustrating the principles of the invention. Moreover, in the figures, like reference numerals designate corresponding parts throughout the different views.

FIG. 1 is a front perspective view showing an example of an implementation of a vehicle steering assembly.

FIG. 2 is a back perspective view of the vehicle steering assembly shown in FIG. 1.

FIG. 3 is a top view of the vehicle steering assembly shown in FIG. 1.

FIG. 4 is a bottom view of the vehicle steering assembly shown in FIG. 1.

FIG. 5 is a front view of the vehicle steering assembly shown in FIG. 1.

FIG. 6 is a back view of the vehicle steering assembly shown in FIG. 1.

FIG. 7 is an enlarged bottom perspective view of a cutaway of the vehicle steering assembly shown in FIG. 6 taken along line A-A.

FIG. 8 is a top exploded view of the vehicle steering assembly shown in FIG. 1.

FIG. 9 is a front perspective view of the vehicle steering assembly shown in FIG. 1, mounted on a motorcycle frame.

FIG. 10 is a back perspective view of the vehicle steering assembly shown in FIG. 1, mounted on the motorcycle frame.

FIG. 11 is a back perspective view showing another example of an implementation of a vehicle steering assembly.

FIG. 12 is an exploded back perspective view of the vehicle steering assembly shown in FIG. 11.

FIG. 13 is a top view of the vehicle steering assembly shown in FIG. 11.

FIG. 14 is a bottom view of the vehicle steering assembly shown in FIG. 11.

FIG. 15 is a back view of the vehicle steering assembly shown in FIG. 11.

FIG. 16 is a front view of the vehicle steering assembly shown in FIG. 1.

FIG. 17 is a partial back view of the vehicle steering assembly shown in FIG. 11.

### DETAILED DESCRIPTION

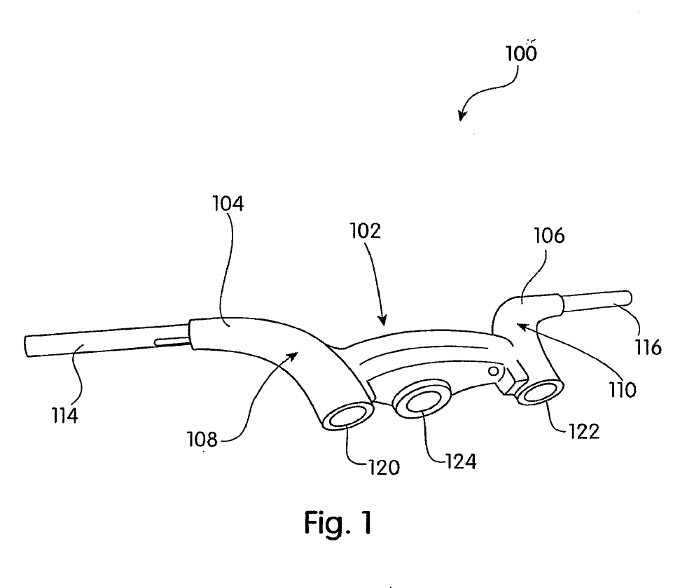

FIG. 1 is a front perspective view showing an example of an implementation of a vehicle steering assembly 100. The vehicle steering assembly 100 includes a triple tree 102 and two handlebars 104, 106. The handlebar 104 is integrated at a transition region 108 with the triple tree 102; and the handlebar 106 is integrated at a transition region 110 with the triple tree 102. It is understood by those skilled in the art that the transition regions 108, 110 may be located at other positions along the handlebars 106, as well as along the triple tree 102. The handlebars 104, 106 may, as an example, be monolithic with the triple tree 102. As illustrated, grip bars 114, 116 may further be integrated with the handlebars 104 and 106. As further illustrated in FIG. 1, the triple tree 102 of the vehicle steering assembly 100 further includes two fork-receiving recesses 120, 122, and a neck-receiving top pipe recess 124 for mounting the vehicle steering assembly 100 on the frame of a vehicle, such as the frame of motorcycle.

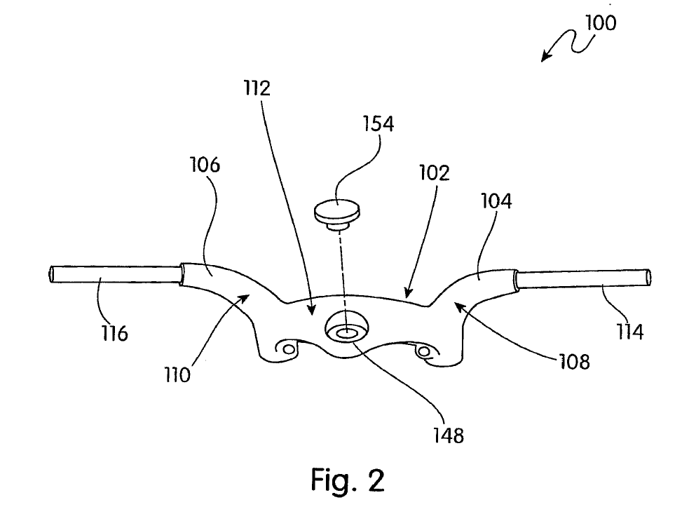

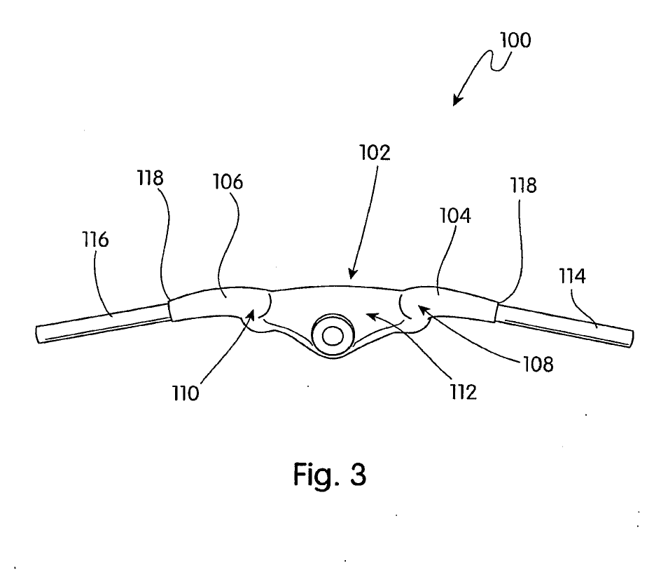

FIG. 2 is a back perspective view of the vehicle steering assembly 100 shown in FIG. 1. In this example, the transition regions 108, 110 may generally have gradually-changing dimensions. As shown in FIGS. 1 and 2, such gradually-changing dimensions may include smooth transitions such that the triple tree 102 and two handlebars 104, 106 may together form an integrated upper surface 112 of the vehicle steering assembly 100. FIG. 3 is a top view of the vehicle steering assembly 100 shown in FIG. 1. As further illustrated, an upper surface 112 of the triple tree 102, may include a removable face plate 154 which when removed, creates an opening 148 aligned with the neck-receiving top pipe recess 124 (see FIG. 1).

FIG. 3 further illustrates the integrated upper surface 112 of the vehicle steering assembly 100. The vehicle steering assembly 100 may, for example, include grip bars 114, 116 respectively integrated with the handlebars 104, 106. The grip bars 114, 116 may be monolithic with the handlebars 104, 106. As another example, the grip bars 114, 116 may be removeably coupled together with the handlebars 104, 106 respectively. The vehicle steering assembly 100 may include a fastener 118 adapted for securing grip bars 114, 116 to the handlebars 104, 106. When the grip bars 114, 116 are monolithic with the handlebars 104, 106 the combination grip bars 114, 116 and handlebars may be treated as a single structure and referred to as simply the handlebars 104, 106.

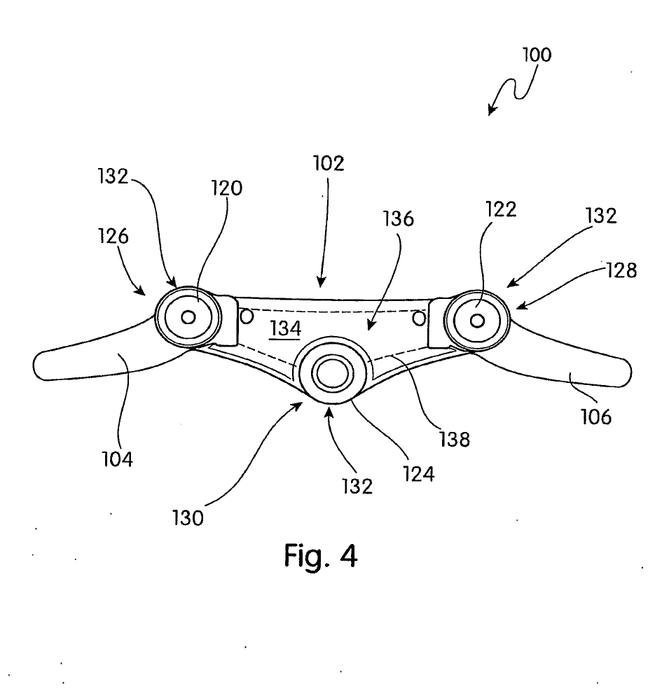

FIG. 4 is a bottom view of the vehicle steering assembly 100 shown in FIG. 1. The triple tree 102 of the vehicle steering assembly 100 includes two fork-receiving recesses 120, 122, and a neck-receiving top pipe recess 124. As an example, the triple tree 102 of the vehicle steering assembly 100 may include three spaced-apart rounded corners 126, 128, 130 each forming a vertex 132 of a triangular body 134 of the triple tree 102. Further in this example, each of the two fork-receiving recesses 120, 122 and the neck-receiving top pipe recess 124 may be located at one of the rounded corners 126, 128, 130. The triangular body 134 of the triple tree 102 may, for example, include a hollow interior 136 as represented by the dotted line 138 for communicating with the two fork-receiving recesses 120, 122, or the neck-receiving top pipe recess 124 or other openings in vehicle steering assembly 100.

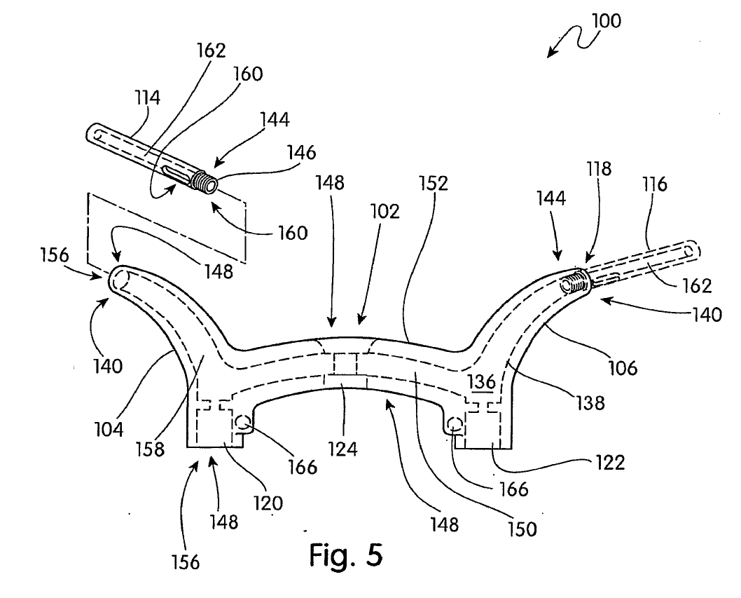

FIG. 5 is a front view of the vehicle steering assembly 100 shown in FIG. 1. As an example, ends 140 of each of the handlebars 104, 106 may include an internally-threaded recess (not shown), and ends 144 of each of the grip bars 114, 116 may include an externally-threaded flange 146. The flanges 146 may be configured for threaded engagement with the internally-threaded recesses, forming a fastener 118 for removeably securing together a grip bar 114, 116 and a handlebar 104, 106.

The triple tree 102 may, as an example, include openings 148 at each of two or more different locations in the triple tree 102 that may be in communication with a hollow interior 136 of the triple tree 102 represented by the dotted line 138. The hollow interior 136 may extend into the handlebars 104, 106 and into the grip bars 114, 116. For example, the hollow interior 136 may include the interior channel 150 communicating with the two openings 148 in the triple tree 102. These openings 148 may be, as examples, at a location aligned with a portion of the triple tree 102 such as a fork-receiving recess 120, 122, or the neck-receiving top pipe recess 124. As a further example, the hollow interior 136 may include the interior channel 158 communicating with the two openings 156 at each of two different locations in the handlebar 104, 106. The hollow interior 136 may, for example, include the interior channel 162 communicating with the two openings 160 at each of two different locations in the grip bar 114, 116. In summary, the vehicle steering assembly 100 may, for example, include two or more interior channels 150, 158, 162, which may be interconnected to form a hollow interior 136 of the steering assembly, represented by dotted line 138.

The vehicle steering assembly 100 may further include vibration-damping material (not shown) in the interior channels 158 in the handlebars 104, 106 and in the interior channels 162 in the grip bars 114, 116. A part of a handlebar 104, 106 or a grip bar 114, 116 may, for example, be solid without an interior channel 158, 162.

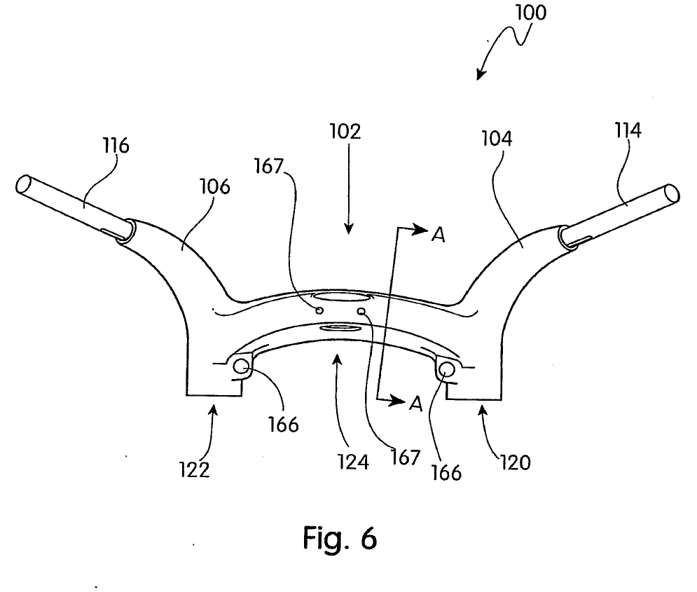

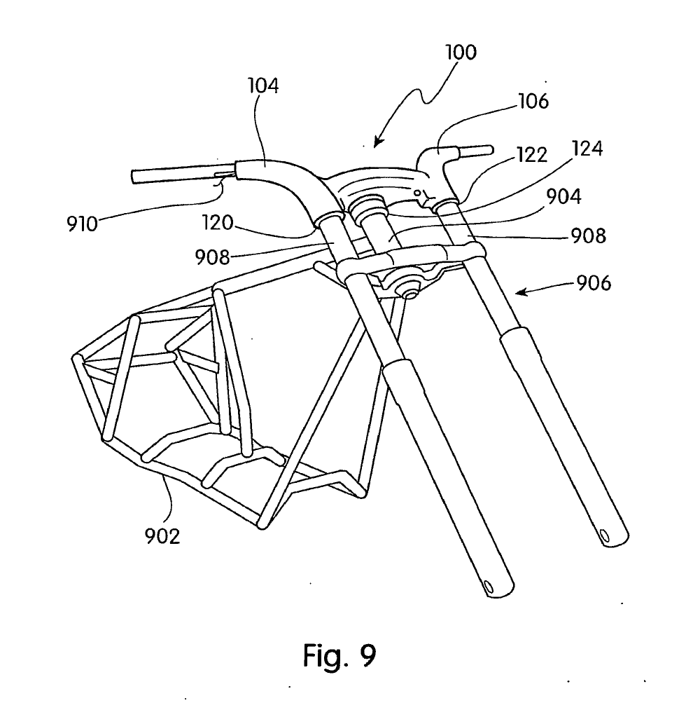

FIG. 6 is a back side view of the vehicle steering assembly 100 shown in FIG. 1. In this example, the two fork-receiving recesses 120, 122 and the neck-receiving top pipe recess 124 may be mutually positioned in a spaced apart triple tree alignment as seen in FIG. 4. The triple tree 102 may take the form of a triangular body 134 (see FIG. 4). The triple tree alignment may be configured for removably coupling the triple tree 102 with a steerable vehicle wheel assembly including a neck 904 and two forks 908 (as illustrated in FIGS. 9 & 10). The neck-receiving top pipe recess 124 may include a fastener (not shown) for removeably coupling together the vehicle steering assembly 100 and a neck 904 (FIG. 9) of a steerable vehicle wheel assembly. The fork-receiving recesses 120, 122 may each include a recess 166 for receiving a fastener (not shown), such as a cam lock or other fastening device, for removeably coupling together the vehicle steering assembly 100 and the forks 908 (FIG. 9) of the steerable vehicle wheel assembly. The fasteners may be aligned respectively with the neck-receiving top pipe recess 124 and with each of the fork-receiving recesses 120, 122.

Also as illustrated in FIG. 6, the vehicle steering assembly 100 may include access holes 167 for accessing the interior channels 150, 158, 162 (see FIG. 5) of the vehicle steering assembly 100. By providing access holes 167, such as those illustrated in FIG. 6, wiring general external to the handlebars may be fed through the internal channel 150, 158, 162 of the vehicle steering assembly 100. For example, the access holes 167 illustrated in FIG. 6 may be used to provide wiring to gauges.

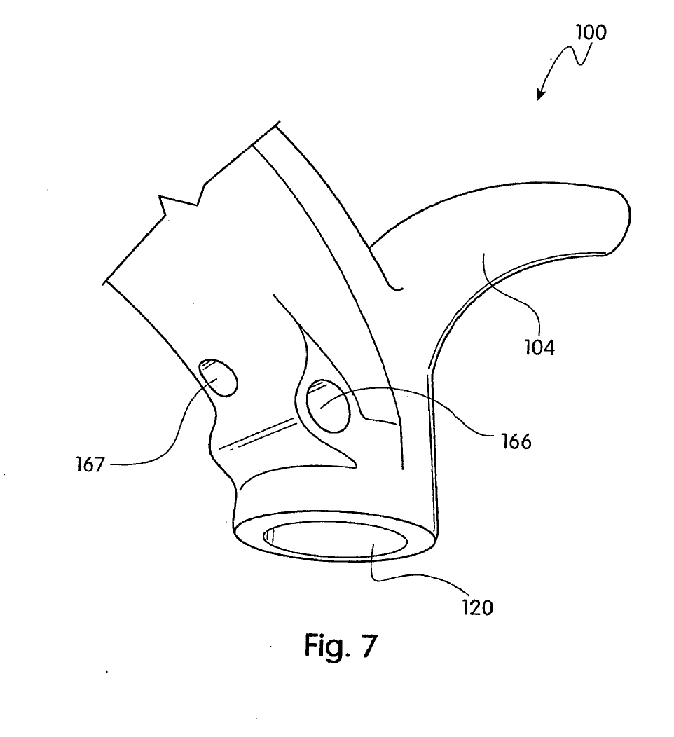

FIG. 7 is an enlarged bottom perspective view of a cutaway of the vehicle steering assembly shown in FIG. 6 taken along line A-A. FIG. 7 illustrates the recess 166 for receiving a fastener, such as a cam lock, for removeably coupling or securing the vehicle steering assembly 100 to the forks 908 (FIG. 9) by inserting one fork 908 into each of the two fork-receiving recesses 120, 122. As further illustrated in FIG. 7, access hole 167 may be provided, which may allow for wires to be fed through the internal channel 150, 158, 162 (FIG. 5) of the vehicle steering assembly 100 to the handle bars or to external gauges, for example.

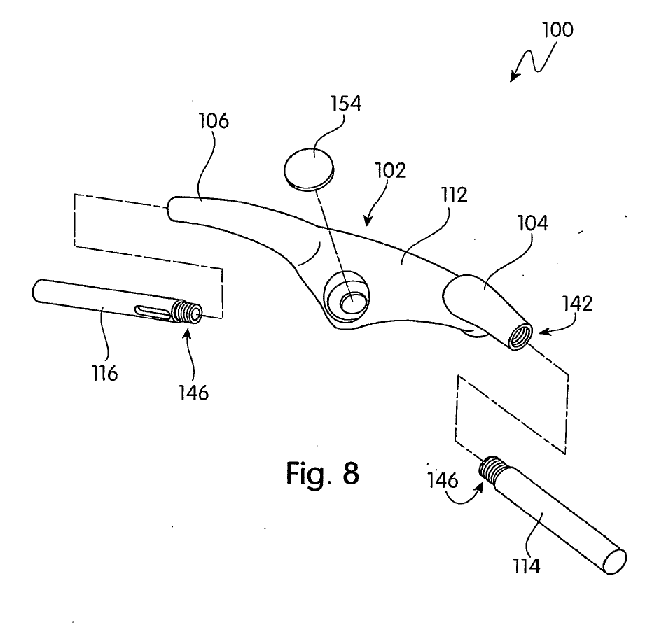

FIG. 8 is a top exploded view of the vehicle steering assembly 100 shown in FIG. 1. FIG. 8 illustrates the grip bars 114, 116 detached from the handlebars 104, 106 of the vehicle steering assembly 100. An internally-threaded recess 142 of a handlebar 104, 106 as well as an externally-threaded flange 146 of a grip bar 114, 116 may also be seen. FIG. 8 also illustrates the face plate 154 detached from the integrated upper surface 112 at a location in the triple tree 102 of the vehicle steering assembly 100.

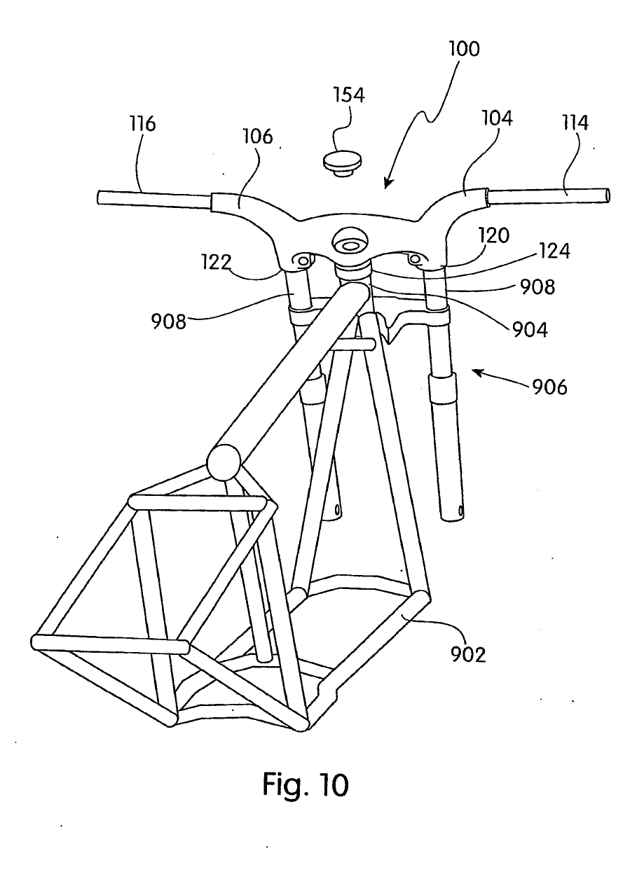

FIG. 9 is a front perspective view of the vehicle steering assembly 100 shown in FIG. 1, mounted on a motorcycle frame 902. FIG. 10 is a back perspective view of the vehicle steering assembly 100 shown in FIG. 1, mounted on the motorcycle frame 902. FIGS. 9 and 10 each show a neck 904, also referred to as a head pipe, of a steerable vehicle wheel assembly 906 of the motorcycle frame 902 mounted on and fastened to the neck-receiving top pipe recess 124.

In particular, FIGS. 9 and 10 show two forks 908 of the steerable vehicle wheel assembly 906 of the motorcycle frame 902 mounted on and fastened to the fork-receiving recesses 120, 122. As an example, the two fork-receiving recesses 120, 122 and the neck-receiving top pipe recess 124 may be mutually positioned in a spaced apart triple tree alignment. The triple tree alignment may be configured for removably coupling the triple tree 102 with the steerable vehicle wheel assembly 906 including the neck 904 and the two forks 908. The vehicle steering assembly 100 may, for example, position the two fork-receiving recesses 120, 122 and the neck-receiving top pipe recess 124 in a spaced apart triple tree alignment enabling simultaneous, reversible coupling of the recesses 120, 122, 124 with the steerable vehicle wheel assembly 906 including coupling with the neck 904 and with the two forks 908. The vehicle steering assembly 100 may facilitate, for example, the concealment and protection of wires 910 such as electrical wires, brake lines, throttle lines, gauge wires and other wires that are typically routed to the handlebars and/or triple tree for controlling and/or monitoring the operation of the vehicle.

Wires 910 may, for example, be routed from the motorcycle frame 902 via a fork 908 or the neck 904 into and through internal channels in the vehicle steering assembly 100 such as shown in FIG. 5. The wires 910 may further, as examples, be routed to exit from the vehicle steering assembly 100 at an opening 148, 156, 160. In an example, the face plate 154 may be removed, and gauges (not shown) may be secured onto the neck 904 and connected to wires 910. It is understood by those skilled in the art that the motorcycle frame 902 is merely an example of a vehicle frame, and that the vehicle steering assembly 100 may be utilized in analogous manners with another vehicle such as an all-terrain vehicle, a moped, or a bicycle, as examples.

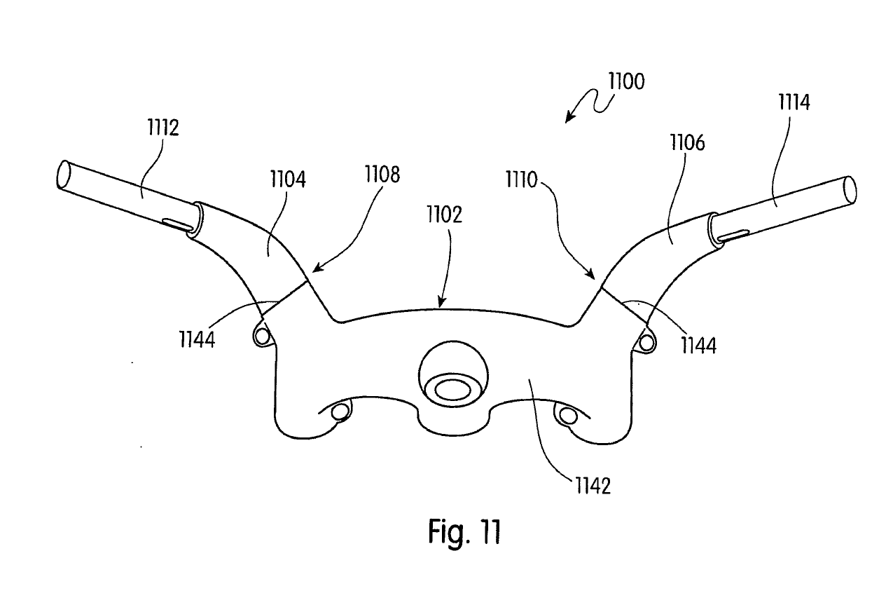

FIG. 11 is a back perspective view showing another example of a vehicle steering assembly 1100. The vehicle steering assembly 1100 includes a triple tree 1102 and two handlebars 1104, 1106. The handlebar 1104 is removeably coupled in a joint 1144 at a transition region 1108 with the triple tree 1102; and the handlebar 1106 is removeably coupled at a transition region 1110 with the triple tree 1102. It is understood by those skilled in the art that the transition regions 1108, 1110 may be located at other positions along the handlebars 1104, as well as along the triple tree 1102. The vehicle steering assembly 1100 may, for example, include grip bars 1112, 1114 removeably coupled together with the handlebars 1104, 1106 respectively.

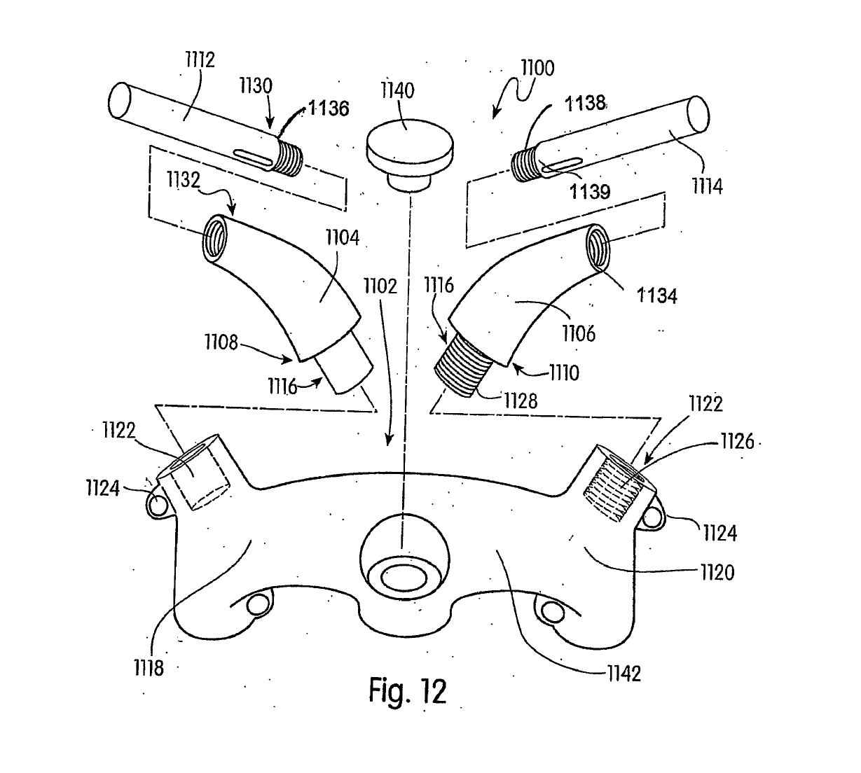

FIG. 12 is an exploded back perspective view of the vehicle steering assembly 1100 shown in FIG. 11. As an example, each of the handlebars 1104, 1106 may include a flange 1116, and the triple tree 1102 may include two handlebar base regions 1118, 1120 each terminating in a recess 1122 configured for receiving and for being removably coupled with a handlebar flange 1116. The vehicle steering assembly 1100 may further include a recess 1124 for receiving a fastener (not shown) configured for removeably securing a handlebar flange 1116 to the handlebar base regions 1118 via recesses 1122. As an example, the fastener may include a cam lock, among other fastening devices.

In another example, each recess 1122 may have interior threads 1126 and each of the handlebars 1104, 1106 may include a flange 1116 having exterior threads 1128 configured for removeably coupling with the interior threads 1126 of a recess 1122. For additional securing measures, the handlebars 1104, 1106 may be secured to the triple tree 1102 utilizing both a fastener, such as a cam lock, and mating threaded male and female parts. It is understood (not shown) that alternatively the triple tree 1102 may include two handlebar base regions 1118, 1120 each including a flange, and each of the handlebars 1104, 1106 may include a recess configured for receiving and being removably coupled with a flange. Further, it is understood by those skilled in the art that the coupling of the handlebars 1104, 1106 and triple three 1102 may be done in a location along the vehicle steering assembly 1102 other than as illustrated in FIGS. 11-17. For example, the handlebars 1104, 1106 may include a base region that when integrated with the triple tree 1102 form part of the triple tree.

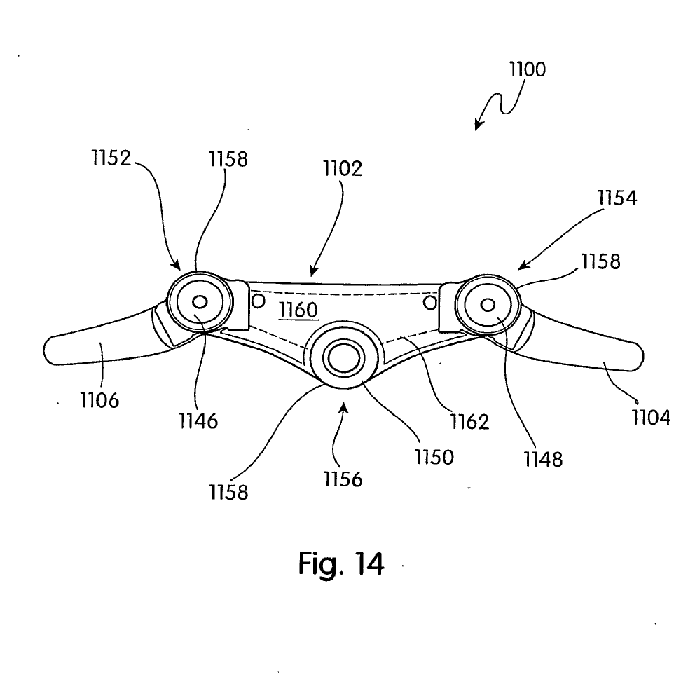

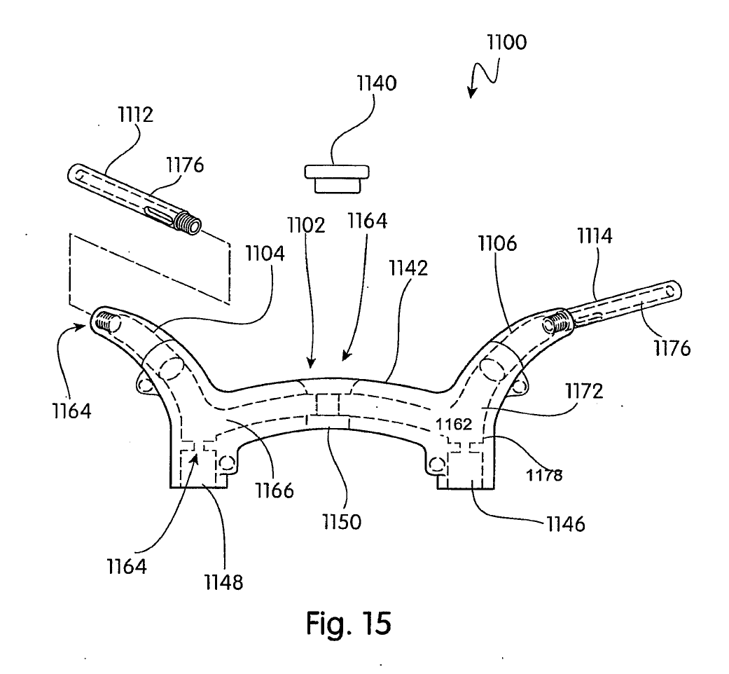

Although not illustrated, the recesses 1124 for the fasteners, such as the cam locks, may be positioned on the underside of the vehicle steering assembly 1100. Additionally, the cam locks may be positioned inside the interior channel 1166, 1172 or hollow interior 1162 of the triple tree 1102 and/or handlebars 1104, 1106 (see FIGS. 14 & 15), accessible through the fork-receiving recesses 1146, 1148 (see FIG. 15).

FIG. 12 also illustrates the grip bars 1112, 1114 detached from the handlebars 1104, 1106 of the vehicle steering assembly 1100. The vehicle steering assembly 1100 may include a fastener 1130 adapted for securing together a grip bar 1112, 1114 and a handlebar 1104, 1106. As an example, ends 1132 of each of the handlebars 1104, 1106 may include an internally-threaded recess 1134, and ends 1136 of each of the grip bars 1112, 1114 may include a flange 1138 with exterior threads 1139. The flanges 1138 may be configured for threaded engagement with the internally-threaded recesses 1134, forming a fastener 1130 for removeably securing together a grip bar 1112, 1114 and a handlebar 1104, 1106. FIG. 12 also illustrates a face plate 1140 detached from an integrated upper surface 1142 at a location in the triple tree 1102 of the vehicle steering assembly 1100.

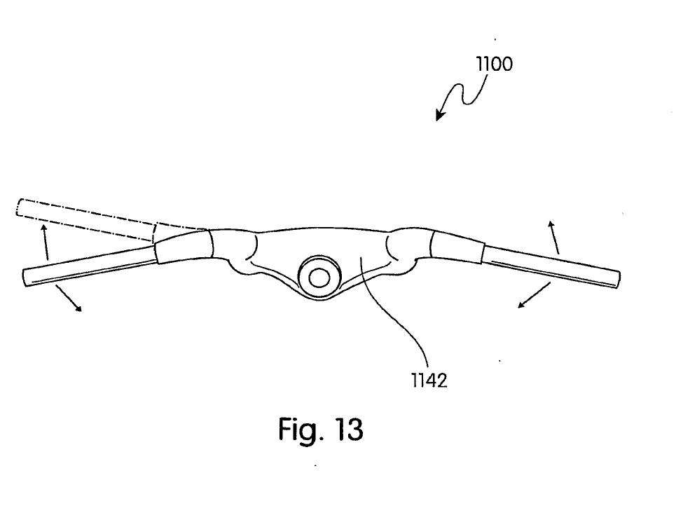

FIG. 13 is a top view of the vehicle steering assembly 1100. FIG. 13 illustrates that the handlebars 1104, 1106 may be adjusted utilizing the modular design. As illustrated, the handlebar 1104, 1106 may be adjusted forward or backward depending upon user preference. Once the handlebars 1104, 1106 are in the desired position, they may be locked into place.

FIG. 14 is a bottom view of the vehicle steering assembly 1100 shown in FIG. 11. The triple tree 1102 of the vehicle steering assembly 1100 includes two fork-receiving recesses 1146, 1148, and a neck-receiving top pipe recess 1150. As an example, the triple tree 1102 of the vehicle steering assembly 1100 may include three spaced-apart rounded corners 1152, 1154, 1156 each forming a vertex 1158 of a triangular body 1160 of the triple tree 1102. Further in this example, each of the two fork-receiving recesses 1146, 1148 and the neck-receiving top pipe recess 1150 may be located at one of the rounded corners 1152, 1154, 1156. The triangular body 1160 of the triple tree 1102 may, for example, include a hollow interior as represented by the dotted line 1162.

FIG. 15 is a back side view of the vehicle steering assembly 1100 shown in FIG. 11. The triple tree 1102 may, as an example, include openings 1164 at each of two or more different locations in the triple tree 1102 that may be in communication with a hollow interior 1162 of the triple tree 1102 represented by the dotted line 1178. The hollow interior 1162 may extend into the handlebars 1104, 1106 and into the grip bars 1112, 1114. For example, the hollow interior 1162 may include the interior channel 1166 communicating with the two openings 1164 in the triple tree 1102. These openings 1164 may be, as examples, at a location aligned with a portion of the triple tree 1102 such as a fork-receiving recess 1146, 1148, or the neck-receiving top pipe recess 1150. As a further example, the hollow interior 1162 may include the interior channel 1172 communicating with two openings (not shown) at each of two different locations in the handlebars 1104, 1106. The hollow interior 1162 may, for example, include the interior channel 1176 communicating with two openings (not shown) at each of two different locations in the grip bar 1112, 1114. In summary, the vehicle steering assembly 100 may, for example, include two or more interior channels including channel 1166, which may be interconnected to form a hollow interior 1162 of the steering assembly, represented by dotted line 1178. The vehicle steering assembly 1100 may include vibration-damping material (not shown) in the interior channels 1166 in the triple tree 1102, in the interior channels 1172 in the handlebars 1104, 1106 and in the interior channels 1176 in the grip bars 1112, 1114. A part of a handlebar 1104, 1106 or a grip bar 1112, 1114 may, for example, be solid without an interior channel 1172, 1176.

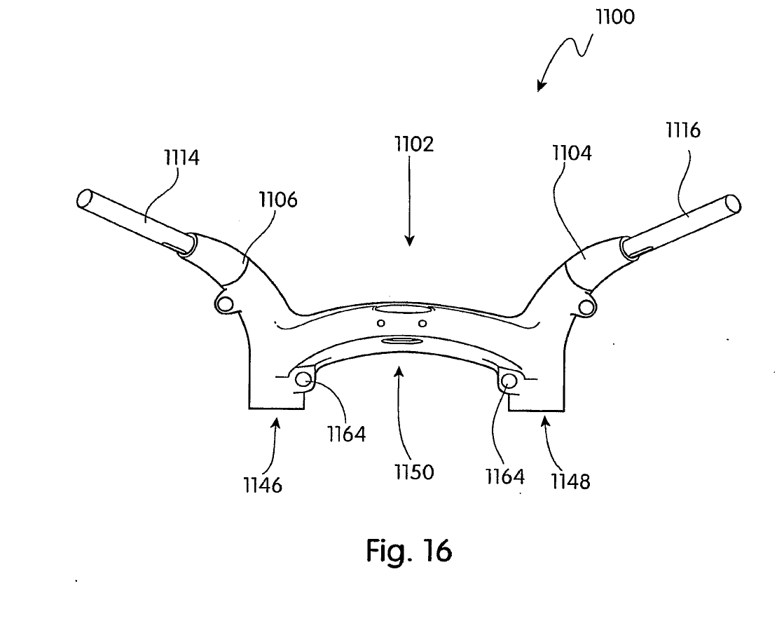

FIG. 16 is a front side view of the vehicle steering assembly 1100 shown in FIG. 11. In an example, the two fork-receiving recesses 1146, 1148 and the neck-receiving top pipe recess 1150 may be mutually positioned in a spaced apart triple tree alignment as seen also in FIG. 15. The triple tree alignment may be configured for removably coupling the triple tree 1102 with a steerable vehicle wheel assembly in the same manner as illustrated in FIGS. 9 & 10 above. The neck-receiving top pipe recess 1150 may include a fastener (not shown) for removeably coupling together the vehicle steering assembly 1100 and a neck 904 (see FIG. 9) of a steerable vehicle wheel assembly. The fork-receiving recesses 1146, 1148 may each include a fastener 1164 for removeably coupling together the vehicle steering assembly 1100 and a fork 908 (see FIG. 9) of a steerable vehicle wheel assembly. Recesses for the fasteners, including recess 1164, may be aligned respectively with the neck-receiving top pipe recess 1150 and with each of the fork-receiving recesses 1146, 1148. The fasteners 1164 may each include a cam lock, as an example.

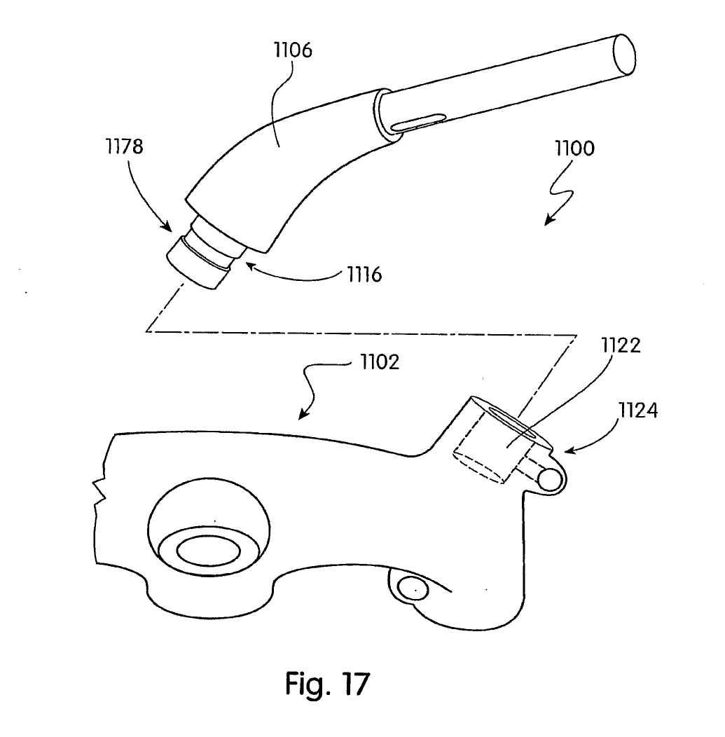

FIG. 17 is a partial back side view of the vehicle steering assembly 1100 shown in FIG. 11. In an example, a handlebar 1106 may include a flange 1116 having a groove 1178. The triple tree 1102 may, for example, include a recess 1122 and recess 1124 for receiving a fastener. The fastener may, as an example, engage with the groove 1178 when the flange 1116 is inserted into the recess 1122, locking the handlebar 1106 to the triple tree 1102. As previously discussed, the recesses 1124 for the fasteners may be positioned on the underside of the vehicle steering assembly 1100. Additionally, the fasteners may be positioned inside the interior channel 1166, 1172 or hollow interior 1162 of the triple tree 1102 and/or handlebars 1104, 1106 (see FIGS. 14 & 15), which may be accessible through the fork-receiving recesses 1146, 1148 (see FIG. 15), for example.

The vehicle steering assembly 1100 may be mounted (not shown) on a motorcycle frame 902 in the same manner as discussed above in connection with the vehicle steering assembly 100 and shown in FIGS. 9 and 10. The vehicle steering assembly 1100 may, for example, position the two fork-receiving recesses 1146, 1148 and the neck-receiving top pipe recess 1150 in a spaced apart triple tree alignment enabling simultaneous, reversible coupling of the recesses 1146, 1148, 1150 with the steerable vehicle wheel assembly 906 including coupling with the neck 904 and with the two forks 908.

The vehicle steering assemblies 100, 1100 may be fabricated from metal alloys and from other materials having strength properties comparable to that of metals. As examples, metal alloys including one or more of aluminum, iron, steel, titanium, vanadium, chromium, molybdenum, are contemplated. It is understood that the vehicle steering assemblies 100 and 1100 are merely examples of vehicle steering assemblies and that many variations are contemplated. The triple tree 102, 1102 may include fork receiving recesses 120, 122, 1146, 1148 and neck-receiving top pipe recesses 124, 1150 oriented in other mutual positions forming a body that may or may not be triangular. The integrated upper surface 112, 1142 of the triple tree may or may not be upwardly arched as shown in FIG. 6. Handlebars 104, 106, 1104, 1106 and grip bars 114, 116, 1112, 1114 may or may not be straight or curved as shown in the figures. Fasteners 118, 164, 166 may include alternatives to threads or cam locks. Openings 148, 156, 160, 1164, 1170, 1174 may be located at other selected positions on the vehicle steering assemblies 100, 1100, as well as access holes 167. Interior channels 150, 158, 162, 1164, 1172, 1176 may have pathways and dimensions through the vehicle steering assembly 100, 1100 selected based on considerations of structural integrity and needs for internal space for wires 910. The face plate 154 may be circular or have any selected size or shape.

In another example of an implementation, a method is provided. The method starts at step 1905, and at step 1910 a vehicle steering assembly 100, 1100 is provided having a triple tree 102, 1102 and two handlebars 104, 106, 1104, 1106, each of the two handlebars 104, 106, 1104, 1106 being integrated at a transition region 108, 110, 1108, 1110 with the triple tree 102, 1102, the triple tree 102, 1102 including two fork-receiving recesses 120, 122, 1146, 1148, a neck-receiving top pipe recess 124, 1150, an opening 148, 1164 at each of two different locations in the triple tree 102, 1102, and a hollow interior including an interior channel 150, 1166 communicating with the two openings 148, 1164 in the triple tree 102, 1102. At step 1915, a wire 910 is routed through the channel 150, 1166 between the two openings 148, 1164, or alternatively through an access hole 167 to opening 1164 or to another access hole 167. The method may then end at step 1920. As an example, routing the wire 910 at step 1915 may include routing the wire 910 through an opening 148, 1164 at a location aligned with a portion of the vehicle steering assembly 100, 1100 selected from the group consisting of a fork-receiving recess 120, 122, 1146, 1148, the neck-receiving top pipe recess 124, 1150, a top surface 152, 1168 of the triple tree 102, 1102, and a surface 166, 1166 of a handlebar 104, 106, 1104, 1106 or through an access hole 167.

In another example, providing a vehicle steering assembly 100, 1100 at step 1910 may include providing a grip bar 114, 116, 1112, 1114 integrated with each handlebar 104, 106, 1104, 1106, each grip bar 114, 116, 1112, 1114 including an opening 160, 1174 at each of two different locations and an interior channel 162, 1176 communicating with the two openings 160, 1174; and routing the wire 910 through the interior channel 162, 1176 between the two openings 160, 1174 in the grip bar 114, 116, 1112, 1114.

The vehicle steering assemblies 100, 1100 may be utilized broadly with motorized and non-motorized vehicles having steerable wheel assemblies. As examples, such vehicles may include motorcycles, all-terrain vehicles, mopeds, bicycles, and aircraft. Motorcycles include, as examples, motorcycles having two wheels, three wheels or four wheels.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

1. A vehicle steering assembly comprising:
a triple tree;
two handlebars, each of the two handlebars being integrated at a transition region with the triple tree; and
the triple tree including two fork-receiving recesses and a neck-receiving top pipe recess.

2. The vehicle steering assembly of claim 1, where the transition regions generally have gradually-changing dimensions.

3. The vehicle steering assembly of claim 1, where the triple tree includes three spaced-apart rounded corners each forming a vertex of a triangular body, each of the two fork-receiving recesses and the neck-receiving top pipe recess being located at one of the rounded corners.

4. The vehicle steering assembly of claim 1, where the triple tree includes a hollow interior.

5. The vehicle steering assembly of claim 1, where the two fork-receiving recesses and the neck-receiving top pipe recess are mutually positioned in a spaced apart triple tree alignment, the triple tree alignment corresponding to an alignment of a steerable vehicle wheel assembly including a neck and two forks, the triple tree alignment being configured for removable coupling the triple tree with such a steerable vehicle wheel assembly.

6. (canceled)

7. (canceled)

8. (canceled)

9. (canceled)

10. The vehicle steering assembly of claim 1, including an opening at each of two different locations in the triple tree, and an interior channel in the triple tree communicating with the two openings.

11. (canceled)

12. (canceled)

13. (canceled)

14. The vehicle steering assembly of claim 1, including an opening at each of two different locations in a handlebars and an interior channel in the handlebar communicating with the two openings.

15. (canceled)

16. The vehicle steering assembly of claim 1, where the handlebars are monolithic with the triple tree.

17. The vehicle steering assembly of claim 1, where the handlebars are removeably coupled with the triple tree.

18. (canceled)

19. (canceled)

20. (canceled)

21. (canceled)

22. (canceled)

23. The vehicle steering assembly of claim 1, including a grip bar integrated with each handlebar.

24. (canceled)

25. (canceled)

26. (canceled)

27. (canceled)

28. (canceled)

29. (canceled)

30. (canceled)

31. (canceled)

32. A vehicle steering assembly comprising a triple tree and two handlebars;
each of the two handlebars being integrated at a transition region with the triple tree;
the triple tree including two fork-receiving recesses, a neck-receiving top pipe recess, and a hollow interior.

33. The vehicle steering assembly of claim 32, including an opening at each of two different locations in the triple tree, where the hollow interior includes an interior channel communicating with the two openings.

34. The vehicle steering assembly of claim 33, including an opening at a location aligned with a portion of the triple tree selected from the group consisting of a fork-receiving recess, the neck-receiving top pipe recess, and a surface of the triple tree.

35. The vehicle steering assembly of claim 32, including an opening at each of two different locations in a handlebar, where the hollow interior includes an interior channel in the handlebar communicating with the two openings in the handlebar.

36. The vehicle steering assembly of claim 35, including an opening at each of two different locations in the triple tree, where the hollow interior includes an interior channel communicating with the two openings in the triple tree and where the interior channels in the handlebar and in the triple tree are interconnected.

37. The vehicle steering assembly of claim 32, including a grip bar integrated with each handlebar.

38. The vehicle steering assembly of claim 37, including an opening at each of two different locations in a grip bar, where the hollow interior includes an interior channel in the grip bar communicating with the two openings in the grip bar.

39. The vehicle steering assembly of claim 38, including an opening at each of two different locations in a handlebar, where the hollow interior includes an interior channel communicating with the two openings in the handlebar and where the interior channels in the handlebar and in the grip bar are interconnected.

40. A method, comprising:
providing a vehicle steering assembly having a triple tree and two handlebars, each of the two handlebars being integrated at a transition region with the triple tree, the triple tree including two fork-receiving recesses, a neck-receiving top pipe recess, an opening at each of two different locations in the triple tree, and a hollow interior including an interior channel communicating with the two openings in the triple tree; and
routing a wire through the channel between the two openings.

41. The method of claim 40, including routing the wire through an opening at a location aligned with a portion of the vehicle steering assembly selected from the group consisting of a fork-receiving recess, the neck-receiving top pipe recess, a surface of the triple tree, and a surface of a handlebar.

42. The method of claim 40, including providing a vehicle steering assembly having a grip bar integrated with each handlebar, each grip bar including an opening at each of two different locations and all interior channel communicating with the two openings; and routing the wire through the channel between the two openings in the grip bar.
